(19) United States
(12) Patent Application Publication
(10) Pub. No.: US 2012/0302132 A1
(43) Pub. Date: Nov. 29, 2012

(54) Vented Top Bar Beehive System

(76) Inventors: Charlie Koenen, Milwaukee, WI (US); Jesse Spanaus, Milwaukee, WI (US)

(21) Appl. No.: 13/526,997

(22) Filed: Jun. 19, 2012

Related U.S. Application Data
(63) Continuation-in-part of application No. 13/481,559, filed on May 25, 2012.
(60) Provisional application No. 61/490,545, filed on May 26, 2011.

(51) Int. Cl. A01K 47/06

(52) U.S. Cl. 449/17

(57) ABSTRACT

The present invention is a vented top bar beehive system comprised of a vented top bar beehive and a harvest box. The beehive contains viewing panels which allow the hive be viewed, providing an education component. In addition, the top bars and honeycomb may be removed from inner chamber for viewing. When a top bar and honeycomb are removed, the bees stay on the honeycomb, reducing the need for protective gear or the bees to be smoked prior to working with the hives. The vented top bar beehive is suited to the way bees naturally want to create their hive and is easy to maintain, making it ideal for noncommercial beekeepers who want to decentralize beekeeping, enhance local pollination and help offset colony collapse.

### CROSS-REFERENCE TO RELATED APPLICATIONS

This application is a continuation-in-part of U.S. Nonprovisional application Ser. No. 13/481,559 filed May 25, 2012, which is hereby incorporated by reference in its entirety. U.S. Nonprovisional application Ser. No. 13/481,559 claims priority to U.S. Provisional application Ser. No. 61/490,545 filed on May 26, 2011 which is hereby incorporated by reference in its entirety.

### FIELD OF INVENTION

The present invention relates to the field of beehives and more particularly to a vented top bar beehive system.

### BRIEF DESCRIPTION OF THE DRAWINGS

FIG. 1 illustrates an exploded view of an exemplary embodiment of a vented top bar beehive.

FIG. 2 illustrates a perspective view of an exemplary embodiment of a vented top bar beehive.

FIG. 3 illustrates a perspective view of the bottom of an exemplary embodiment of a top bar.

FIG. 4 illustrates a top view of a plurality of top bars and a spacer bar.

FIG. 5 illustrates a perspective view of an exemplary embodiment of a feeder bar.

FIG. 6 illustrates a perspective view of an exemplary embodiment of a harvest box.

### GLOSSARY

As used herein, the term “bee-controlled vent” refers to a vent to a hive or within a hive which is controlled or altered by bees depositing or removing propolis. A bee-controlled vent may be located at a bar ventilation groove between vented top bars of a vented top bar beehive.

As used herein, the term “bar ventilation groove” refers the space between the vented top bars. The bar ventilation groove is the location where the bees deposit, remove or shape propolis.

As used herein, the term “centered comb connection surface” is a surface a honey comb attaches. A comb connection surface must be generally centered to that the comb is directly affixed to the center of the top bar so that surface contact is maximized.

As used herein, the term “colony” refers to a distinguishable localized population within a species.

As used herein, the term “cradle component” refers to a structure which substantially encloses, houses or protects a beehive or colony. A cradle component may be a man-made or naturally occurring structure.

As used herein, the term “framed hive” refers to a hive which uses rigid or semi-rigid structural components to construct frames to contain honeycomb, usually based on wax foundation.

As used herein, the term “hive” refers to a structure which encloses a bee colony

As used herein, the term “inner chamber” refers to space within a cradle.

As used herein, the term “manually applied beeswax” refers to the manual placement of natural wax, produced in the hive of honey bees, to the centered comb connection surface on a top bar of a vented top bar beehive by a human, such as a beekeeper.

As used herein, the term “manually controllable vent” means a vent which a beekeeper can control or adjust. A manually controllable vent may be located in the sliding vent board. A manually controllable vent is a two board system used to regulate moisture and temperature in the hive by adjusting the positioning of vent bars in relation to one another. Each board has a plurality of apertures which may be of various sizes and shapes.

As used herein, the term “propolis” refers to a resinous material which bees collect from tree buds, sap flows, and other botanical sources and deposit to alter their habitat.

As used herein, the term “propolis determined airflow” refers to airflow which is altered or determined by the natural activity of bees depositing propolis.

As used herein, the term “screen bottom board” is a horizontally disposed component provides ventilation and/or which may retain solid material within the hive. A screen bottom board may be removable, interchangeable, disposable, or affixed. A screen bottom board may protect a hive, allow for ventilation and capture debris.

As used herein, the term “vent board” refers to a component which provides a physical barrier to regulate moisture and temperature inside a hive. Vent boards may be adjusted by sliding, twisting or any other physical movement or displacement known in the art.

As used herein, the term “slotted” is used to describe physical components having at least one narrow opening, a groove or slit.

As used herein, the term “top bar hive” refers to any hive that has structural components, such as bars, to which honeycomb may be affixed.

As used herein, the term “vent” refers to any opening or aperture which is specifically placed, configured, or proportioned to facilitate air flow.

As used herein, the term “vented top bar” refers an elongated bar with at least one bar ventilation groove and a centered comb connection surface which has a manually applied beeswax coating. Each end of a vented top bar has a bar removal tab, an auto centering finger groove and a wax comb offset space. A plurality of the vented top bars is placed together across the top of the cradle with the ends of the vented top bars resting on shelves.

### BACKGROUND

It is estimated that one-third of the human food supply is impacted by insect pollination, most of which is accomplished by bees. Cultivated crops and naturally occurring seeds, nuts, berries, and fruits are dependent on the bee pollination.

Since 2006, there has been a dramatic reduction in the number of honey bees in the United States, referred to as colony collapse disorder, and a significant though somewhat gradual decline in the number of colonies maintained by beekeepers. Some beekeepers keep bees for honey, propolis, and other products they produce, while others keep honey bees strictly for their use in pollination. A beekeeper may keep honey bees in hives, boxes, or other receptacles.

Artificial beehives are known in the art. The Langstroth hive is the standard framed beehive used in many parts of the world for beekeeping. The Langstroth hive is comprised of a telescoping or migratory cover; an inner cover; one or more hive bodies or honey supers, which are four-sided boxes that contain eight to ten frames and which are used to collect the honey; and a bottom board. The bees build honeycomb into the frames. The frames are designed so that the bees do not attach wax honeycomb between the frames or to the walls of the hive and do not cement the frames to the side of the box using propolis, allowing the beekeeper to move the frames. The ability to move the frames allows the beekeeper to manage the bees.

The Warré is another example of an artificial hive used by beekeepers. The hive body is made of boxes stacked vertically, using top bars for honeycomb support instead of full frames. When the bees need more space as the colony expands, a new box is positioned underneath the existing boxes.

These stacked box hives are designed for maximum production and are ideal for commercial bee keepers; however, they are cumbersome and a less than ideal place for bees. In addition, protective gear is required while working with and tearing apart the hives.

### SUMMARY OF THE INVENTION

The present invention is a vented top bar beehive system comprised of a vented top bar beehive and a harvest box. The vented top bar beehive includes a cradle, four legs which are secured to cradle and raise the cradle off the ground, and a curved lid. A screen bottom board is positioned at the open bottom of the cradle, providing ventilation to the hive. A sliding vent board is positioned below the screen bottom board. The sliding vent board may be adjusted to regulate the temperature and moisture inside the hive.

Top bars are added to the cradle interior and provide a surface for the bees to hang honeycombs. The top bars contain bar ventilation grooves which allow for ventilation. A feeder bar and/or a follower bar are used to enclose the top bars, creating an inner chamber. Additional spacer bars may be added between the top bars to accommodate wide honeycombs and maintain space for the bees to move between the honeycombs.

The lid is used to seal the cradle and inner chamber and creates a vapor barrier from wind, rain, and snow, insulating and protecting the inner chamber in extreme hive conditions. The lid further includes vents which provide ventilation.

The harvest box is used to store full top bars, which are removed from the inner chamber of the beehive. During winter, the full top bars are returned to the hive to provide food for the bee during the winter months.

It is desirable to have a top bar hive that is affordable to maintain, easy to use, and geared toward noncommercial beekeepers.

It is desirable to have a top bar hive which allows the hive to be easily viewed, adding an educational component to bees and beekeeping.

It is desirable to have a top bar hive which includes a vent system.

It is desirable to have a top bar hive which includes an internal feeder.

### DETAILED DESCRIPTION OF DRAWINGS

For the purpose of promoting an understanding of the present invention, references are made in the text to exemplary embodiments of a vented top bar beehive system, only some of which are described herein. It should be understood that no limitations on the scope of the invention are intended by describing these exemplary embodiments. One of ordinary skill in the art will readily appreciate that alternate but functionally equivalent materials, components, and designs may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead, emphasis has been placed upon illustrating the principles of the invention. In addition, in the embodiments depicted herein, like reference numerals in the various drawings refer to identical or Near identical structural elements.

Moreover, the terms “substantially” or “approximately” as used herein may be applied to modify any quantitative representation that could permissibly vary without resulting in a change in the basic function to which it is related.

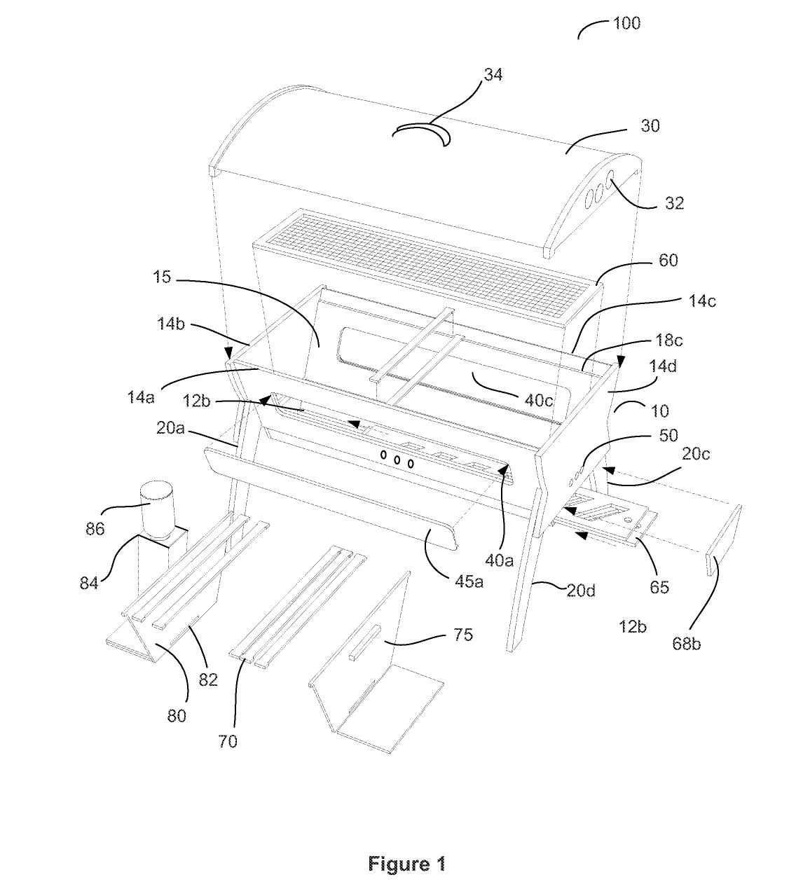

FIG. 1 illustrates an exploded view of an exemplary embodiment of vented top bar beehive 100. In the embodiment shown, vented top bar beehive 100 is comprised of cradle component 10, cradle support members 20a, 20b, 20c, 20d (cradle support member 20b not visible) which are secured to cradle component 10, and curved lid component 30. Cradle component 10 includes inner chamber 15 which in the embodiment shown is comprised of a plurality of top bars, a screen bottom board, a follower bar, and a feeder bar. In various other embodiments, inner chamber 15 may include more or fewer components, such as spacer bars, and various components may be constructed from multiple parts or from integrally constructed parts.

In the embodiment shown, cradle support members 20a, 20b, 20c, 20d are contoured and angle outward slightly. Cradle support members 20a, 20b, 20c, 20d raise cradle component 10 to working height and bring cradle component 10 and the bees off of the ground, reducing moisture. In the embodiment shown, cradle support members 20a, 20b, 20c, 20d are secured to cradle component 10 using machine bolt fittings. In various other embodiments, ground fastening footings may be secured to the bottoms of cradle support members 20a, 20b, 20c, 20d for windy environments or intruder-prone conditions.

In the embodiment shown, cradle component 10 is comprised of side panels 14a, 14b, 14c, 14d. In the embodiment shown, cradle component 10 has a rectangular shape with side panels 14a, 14c angled slightly inward from top to bottom while side panels 14b, 14d are vertical. Side panels 14a, 14c are elongated and have a length approximately twice that of vertical side panels 14b, 14d. The inside of side panels 14a, 14c includes shelves 18a, 18c (shelf 18a not visible) for supporting top bars 70. In various other embodiments, the angle or positioning of one or more sides may vary.

In the embodiment shown, side panels 14a, 14c of cradle component 10 include viewing panels 40a, 40c which allow the inside of inner chamber 15 to be viewed. Shutters 45a, 45c (45c not visible) are attached to the front and back of cradle component 10 to cover viewing panels 40a, 40c when not in use. In the embodiment shown, viewing panels 40a, 40c are secured to side panels 14a, 14c using pop fitting; however, in various other embodiments, substantially transparent viewing panels 40a, 40c may be secured using another hardware fastening means known in the art and commercially available (e.g., through http://www.fastenal.com).

In various other embodiments, one or both of viewing panels 40a, 40c may be omitted.

In the embodiment shown, three bee entrances 50 are located on each of side panels 14a, 14b, 14c, 14d of cradle component 10. The beekeeper decides which bee entrances 50 to use based on site placement then closes the others with entrance plug 52 (not shown). Bee entrances 50 may also be plugged during cold weather to reduce access to the hive or to seal all bee entrances 50 during chemical spraying. In the embodiment shown, bee entrances 50 have a diameter of approximately ¾ inch. In various other embodiments, fewer or more bee entrances 50 of varying sizes may be located on one or more side panels of cradle component 10. However, in most exemplary embodiments, bee entrance apertures 50 have a diameter no greater than 1 inch.

In the embodiment shown, the bottom of cradle component 10 is open and has slots 12a, 12b (12a not visible) for supporting screen bottom board 60 and vent board 65. Screen bottom board 60 rests on slot 12a (the top slot) and vent board 65 rests on slot 12b (the bottom slot). Screen bottom board 60 is a mesh screen which provides ventilation to the hive. Without proper air circulation, moisture can accumulate, which can be devastating to the bees. Screen bottom board 60 also protects against infestation. As the bees clean mites off their backs, the mites will fall through screen bottom board 60 rather than jumping onto another bee. In addition, screen bottom board 60 provides the bees with much-needed protection from other animals.

In the embodiment shown, vent board 65 is comprised of a set of slatted wooden boards with a plurality of apertures. Vent board 65 is used to regulate moisture and the temperature in the hive by adjusting the positioning of the vent bars in relation to one another. For example, during the cold winter the vent bars may be kept partially open and during the summer, vent board 65 may be removed to allow air into the hive via screen bottom board 60. In various other embodiments, vent board 65 may include one or more additional boards. In addition, vent board 65 may be removed and replaced with a solid board for checking for mite infestation.

In the exemplary embodiment shown, vent board 65 is adjusted by sliding, However, in further exemplary embodiments, vent board 65 may be adjusted by rotating, swinging, or any other means known an the art. order to accommodate different means of adjustment, vent board 65 may secure to cradle component 10 through any means known in the art.

A plurality of top bars 70 are placed together across the top of cradle component 10. The ends of top bars 70 rest on shelves 18a, 18c (shelf 18a is not visible) which support the weight of top bars 70 and attached honeycomb. In the embodiment shown, shelves 18a, 18c are perpendicular to side panels 14a, 14c, but angled in relation to top bars 70 when top bars 70 are positioned on shelves 18a, 18c. In the embodiment shown, top bars 70 are approximately 19 inches long; however, in various other embodiments, the length of top bars 70 may be longer or shorter depending on the dimensions of cradle component 10.

As the bees complete the honeycombs on the existing top bars 70, additional top bars 70 can be added to expand inner chamber 15 horizontally, rather than vertically. The ability to expand inner chamber 15 horizontally rather than vertically makes the hive easier to care for and safer to view.

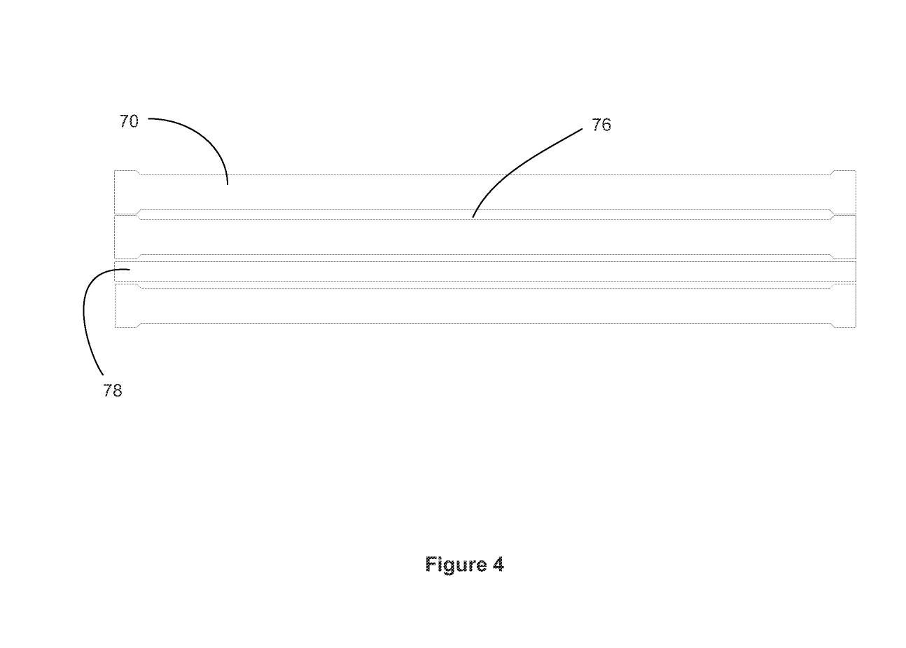

In various embodiments, one or more narrow spacer bars 78 (not visible, see FIG. 4) may be placed between top bars 70 to expand the space for honeycombs as the bees may build their honeycombs wider than the top bars. In addition, spacer bars 78 allow inner chamber 15 to be expanded to give the bees space to move between wider honey-filled combs.

Follower bar 75 and feeder bar 80 are placed outside top bars 70 to enclose the area, creating inner chamber 15 for the bees to begin their colony. Follower bar 75 and feeder bar 80 rest on shelves 18a, 18c similar to top bars 70. Both follower bar 75 and feeder bar 80 include a solid vertical portion that walls off inner chamber 15 and a horizontal portion.

In some exemplary embodiments, two follower bars 75 may be used to enclose an inner chamber 15 and feeder bar 80 may be omitted. As a bee colony expands, follower bars 75, or follower bar 75 and feeder bar 80, may be moved further apart from each other to allow additional room for bees.

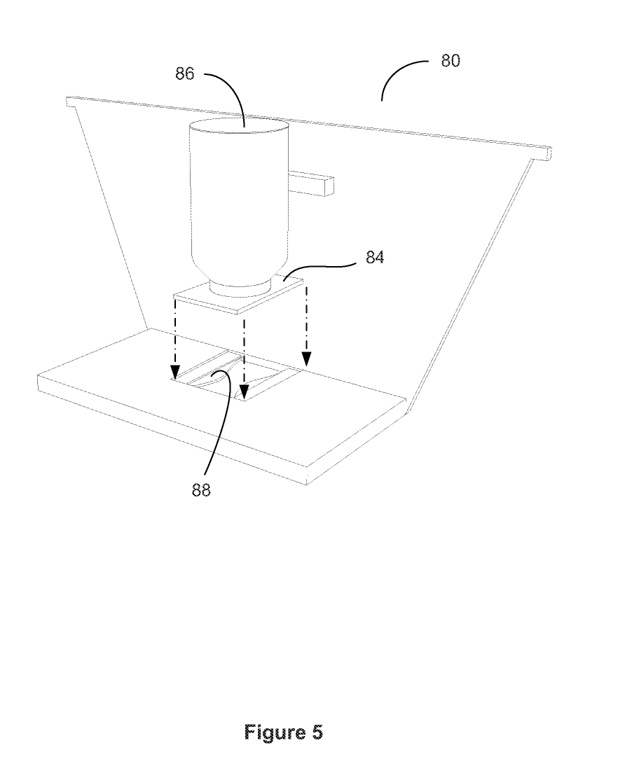

In the embodiment shown, feeder bar 80 includes slotted bee entrance 82 on the side of the horizontal portion that is inside inner chamber 15. The top of the horizontal surface includes removable board 84 which contains an aperture for inserting the lid of Mason jar 86. Removable board 84 raises Mason jar 86. Underneath removable board 84 is shelf 88 (see FIG. 5) which prevents Mason jar 86 from squishing the bees.

In the exemplary embodiment shown, sugar water is placed inside container 86. In the exemplary embodiment shown container 86 is a quart sized Mason jar but may be any container or receptacle known in the art. The lid contains apertures which allow the bees to get at the sugar water. The sugar water provides food for the bees in spring when there are not a lot of flowers and enables the bees to produce wax they use to build the honeycombs. In the embodiment shown, Mason jar 86 is a quart-sized Mason jar. In other embodiments, the size of Mason jar 86 may vary. Sugar water may include or be replaced by any bee nutrient known in the art.

Curved lid 30 is used to seal cradle component 10 and inner chamber 15. Curved lid 30 creates a vapor barrier from wind, rain, and snow, insulating and protecting inner chamber 15 in extreme hive conditions. In the embodiment shown, each end of curved lid 30 contains three vents 32 which provide year-round ventilation. Handle 34 allows for easy removal of curved lid 30 from cradle component 10 (e.g., to remove full top bars). In the embodiment shown, handle 34 is comprised stainless steel, zinc, or another material suited for extended outdoor use.

In the embodiment shown, most of the components of vented top bar beehive 100 are comprised of wood treated with EcoWood (Int. EcoWood Treatment Ltd.), an organic compound that changes the properties of the wood, making it grey and age without rotting. In still other embodiments, plastic, metal, resins, fiberglass and other natural and synthetic materials capable of forming the necessary structure may be used.

Vented top bar beehive 100 is suited to the way bees naturally want to create their hives. Vented top bar beehive 100 is easy to maintain, making it ideal for noncommercial beekeepers who want to decentralize beekeeping to help offset colony collapse. Top bars 70 and honeycomb may be removed from inner chamber 15 for viewing. In the exemplary embodiment shown, when a top bar and honeycomb are removed, the bees stay on the honeycomb, reducing the need for protective gear or the bees to be smoked prior to working with the hives. The ability to view the hive through viewing panels 40a, 40b and to remove the top bars and honeycomb provides an educational component to vented top bar beehive 100.

In addition, the beekeeper may harvest the honey and propolis from any additional full top bars (i.e., full top bars beyond what needs to be returned to the hive in winter).

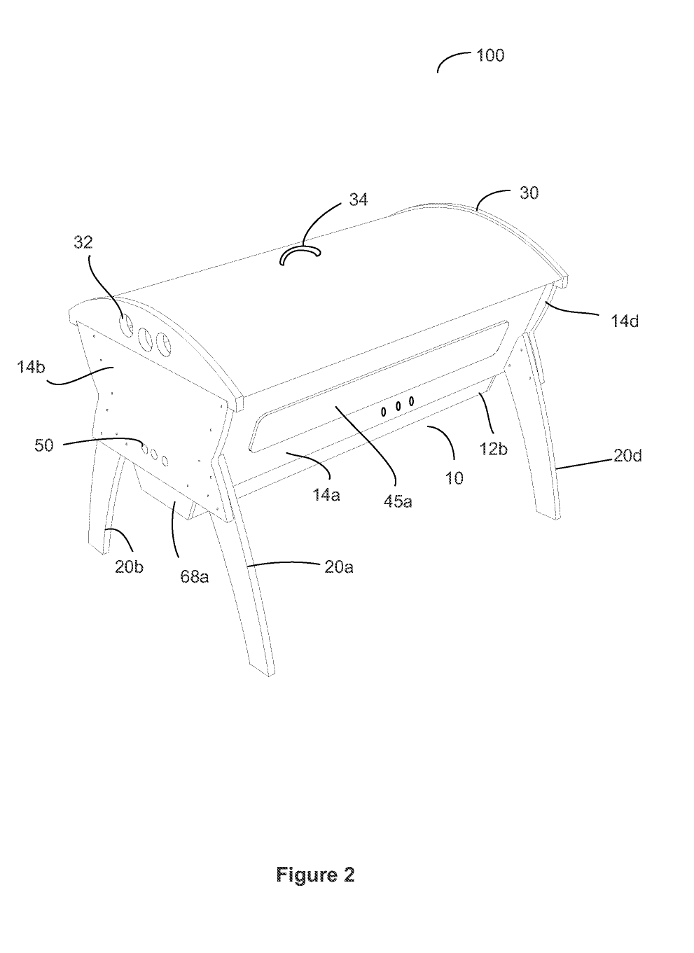

FIG. 2 illustrates a perspective view of an exemplary embodiment of vented top bar beehive 100.

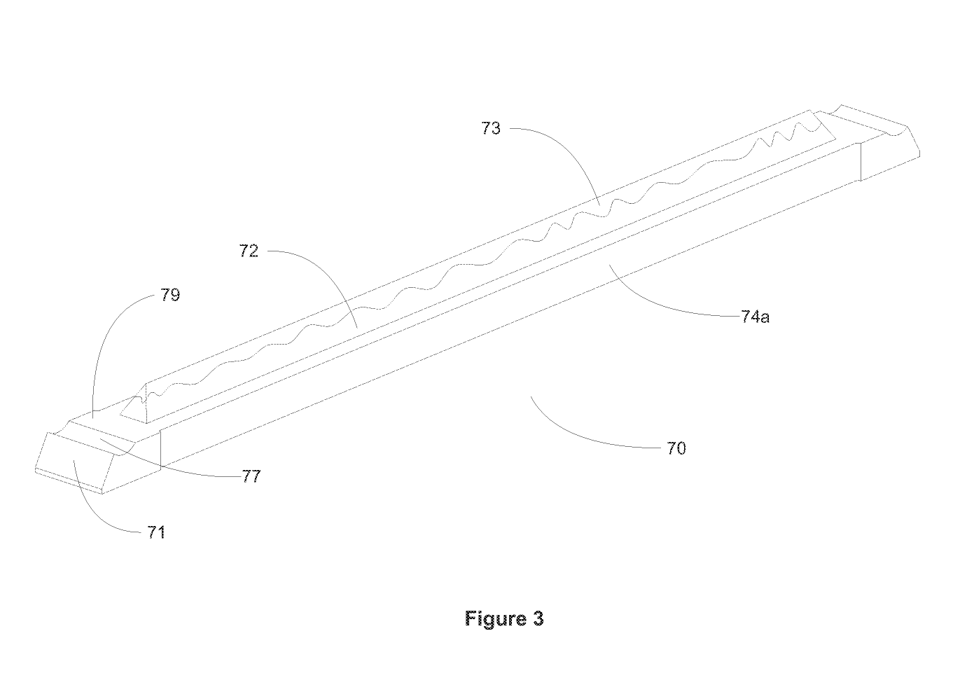

FIG. 3 illustrates a perspective view of the bottom of an exemplary embodiment of top bar 70, Visible are bar removal tab 71, wax comb offset space 79, auto centering finger groove 77, bar ventilation groove 74a (74b not shown), centered comb connection surface 72, and manually applied beeswax 73.

In the embodiment shown, top bars 70 have centered comb connection surface 72 and bar ventilation groove 74a (74b not shown) machined into each side, which create vent space 76 (not shown) between top bars 70 for additional ventilation (see FIGS. 3 and 4). Centered comb connection surface 72 of top bars 70 is dipped in manually applied beeswax 73 (see FIG. 3) and bees will instinctively begin hanging wax honeycomb down from the top bar.

In the exemplary embodiment shown, centered comb connection surface 72 extends approximately ¼ inch to 1 inch vertically from the bottom surface of top bar 70 and has a triangular or pyramidal shape. In further exemplary embodiments, centered comb connection surface 72 may be any shape known in the art to hold beeswax and provide a structure on which honeycomb may be built.

FIG. 4 illustrates a top view of a plurality of top bars 70 and vent space 76. Also visible is optional hardware spacer 78, which is placed between adjacent top bars 70 to expand the space for honeycombs and allow bees to move between them. As illustrated, hardware spacer 78 is a bar having a length corresponding to that of top bars 70. The width of hardware spacer 78 may vary. A vented top bar beehive 100 (not shown) may include more than one hardware spacer 78.

As illustrated in FIG. 4, vent space 76 is hexagonal when top bars 70 are in physical contact with each other. With the addition of hardware spacer 78, a single hexagonal vent space 76 is divided into two trapezoidal vent spaces.

FIG. 5 illustrates a perspective view of an exemplary embodiment of feeder bar 80. Visible are removable board 84, container 86, and shelf 88. Feeder bar 80 may be used in vented top bar beehive 100 (not shown) to provide a food source for bees during winter months or when a supply is scarce.

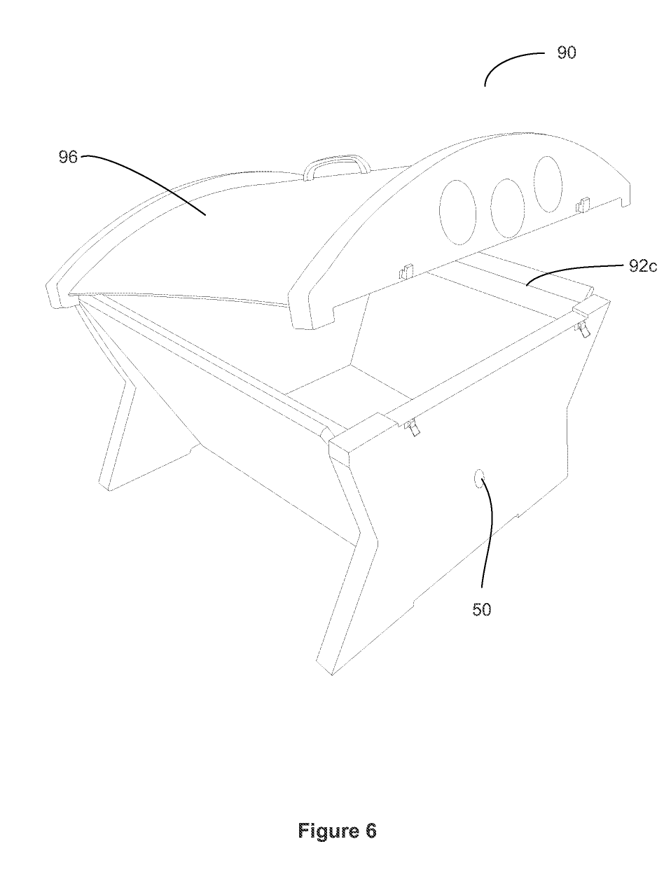

FIG. 6 illustrates a perspective view of an exemplary embodiment of harvest box 90. When a top bar 70 (not shown) is full (i.e., honeycomb is full), top bar 70 and attached honeycomb are removed and stored in harvest box 90. Subsequent full top bars 70 are removed and stored in harvest box 90. In the embodiment shown, harvest box 90 has shelves 92a, 92c on which top bars 70 (not shown) rest (similar to vented top bar beehive 100).

In an exemplary embodiment, harvest box 90 stores up to 10 bars; however, in various other embodiment, harvest box 90 may be sized to store a smaller or larger number of full top bars.

Harvest box 90 stores the full top bars in a sealed or substantially sealed environment. In an exemplary embodiment, harvest box 90 is kept in an indoor environment. In winter, the full bars are returned to inner chamber 15 of vented top her beehive 100 to provide food for the bees during the winter months, allowing the bees to survive the winter. In the embodiment shown, harvest box 90 has a solid bottom and hinged lid 96 that latches to tightly seal harvest box 90.

In the exemplary embodiment shown, harvest box 90 opens such that top bars 70 (not shown) may be placed parallel to the opening (perpendicular to the handle on harvest box 90). In various other embodiments, hinged lid 96 may be attached to harvest box 90 in any orientation, or may not be hinged or attached to harvest box 90 at all.

In various other embodiments, harvest box 90 may be used as a swarm catcher (e.g., by adding queen bee pheromone scent to attract bees) or as a top bar hive transport box. In the embodiment shown, harvest box 90 has two bee entrances 50, located on opposite sides of harvest box 90; however, in various other embodiments, harvest box 90 may have more or fewer bee entrances 50.

What is claimed is:

1. A vented top bar beehive apparatus comprised of:
a cradle component creating an inner chamber, wherein said cradle component includes
two vertical side panels, and
two elongated sloped side panels having an inner surface, wherein each of said inner surfaces has at least one groove to accommodate at least one vented top bar,
wherein said two elongated sloped side panels have a length that is twice the length of the length of said vertical side panels;
said at least one vented top bar comprised of
an upper surface,
a bottom surface including a centered comb connection surface which extends one-fourth to one inch vertically from said bottom surface of said vented top bar,
at least one bar ventilation groove,
at least one bar removal tab, and
at least one auto centering finger groove;
a plurality of cradle support members secured at an angle to said cradle component;
a curved lid component having a first end and a second end; and
a vented bottom.

2. The apparatus of claim 1 wherein said centered comb connection surface further includes a layer of manually applied bees wax.

3. The apparatus of claim 1 when said centered comb connection surface is triangularly shaped.

4. The apparatus of claim 1 which includes a plurality of vented top bars having two bar ventilation grooves running along the length of each of said vented top bars to form a hexagonal aperture between said vented top bars when said vented top bars are in physical contact.

5. The apparatus of claim 4 which further includes at least one hardware spacer bar to form a trapezoidal aperture between at least two of said vented top bars.

6. The apparatus of claim 1 wherein said two vertical side panels further include a plurality of bee entrance apertures, wherein each bee entrance aperture has a diameter no more than one inch.

7. The apparatus of claim 1 wherein said two elongated sloped side panels further include a plurality of bee entrance apertures.

8. The apparatus of claim 1 wherein at least one of said two elongated sloped side panels further includes a viewing panel.

9. The apparatus of claim 8 wherein said viewing panel includes a shutter which substantially covers said viewing panel and includes a viewing aperture with a selectively removable cover, wherein said viewing aperture is covered with a material which is sufficiently transparent to allow bees to be viewed within said inner chamber of said cradle.

10. The apparatus of claim 1 which further includes a plurality of vents positioned at said first end and said second end of said curved lid component.

11. The apparatus of claim 1 wherein said vented bottom is comprised of at least one vent board.

12. The apparatus of claim 11 wherein said vent board contains a plurality of slotted apertures.

13. The apparatus of claim 1 wherein said vented bottom is comprised of a first slotted vent board which moves slidingly over a second slotted vent board.

14. The apparatus of claim 1 wherein said vented bottom is comprised of a screen bottom board.

15. The apparatus of claim 1 which further includes a pair of follower bars having a solid vertical portion and a horizontal portion and the size of said inner chamber is adjustable using said solid vertical portions of said follower bars.

16. The apparatus of claim 15 wherein one of said follow bars is a feeder bar.

17. The apparatus of claim 16 which further includes a slotted bee entrance on said horizontal portion of said internal feeder bar.

18. The apparatus of claim 15 wherein said follower bars are placed outside said at least one vented top bar and rest on said at least one groove of said inner surface of said two elongated sloped side panels.

19. A vented top bar beehive system comprised of:
a cradle component creating an inner chamber, wherein said cradle component includes
two vertical side panels, and
two elongated sloped side panels having an inner surface, wherein each of said inner surfaces has at least one groove;
a plurality of cradle support members secured to said cradle;
a curved lid component having a first end and a second end;
a plurality of vented top bars, each of said vented top bars comprised of
an upper surface,
a bottom surface with a centered comb connection surface which extends one-fourth to one inch vertically from said bottom surface,
at least one bar ventilation groove,
at least one bar removal tab, and
at least one auto centering finger groove;
a vented bottom; and
a harvest box.

20. The system of claim 19 wherein said harvest box includes a hinged lid and pair of grooves contoured to secure at least one of said plurality of vented top bars.
